(19) United States
(12) Patent Application Publication
(10) Pub. No.: US 2005/0284560 A1
(43) Pub. Date: Dec. 29, 2005

(54) Method for producing a fabric having low modulus of elasticity and high stretchability

(75) Inventor: Chi-Chou Chuang, Tung-Shan Hsiang (TW)

Correspondence Address: OSTROLENK FABER GERB & SOFFEN, 1180 AVENUE OF THE AMERICAS, NEW YORK, NY, 100368403, US

(73) Assignee: Shei Chung Hsin Ind. Co., Ltd.

(21) Appl. No.: 10/877,898

(22) Filed: Jun. 24, 2004

(51) Int. Cl. B32B 37/00

(52) U.S. Cl. 156/155; 156/305

(57) ABSTRACT

A method for producing a fabric having low modulus of elasticity and high stretch ability includes the steps of: (a) making an elastic composite fabric from an elastic fiber and a non-elastic fiber; (b) laminating the elastic composite fabric with a rubber sponge layer to form a laminate; (c) treating the elastic composite fabric of the laminate with a solvent so as to dissolve or break the elastic fiber; and (d) removing the solvent from the laminate.

### BACKGROUND OF THE INVENTION

1. Field of the Invention

The invention relates to a method for producing a fabric, more particularly to a method for producing a fabric having low modulus of elasticity and high stretch ability.

2. Description of the Related Art

A conventional fabric for production of wet suits or heat-retaining suits is made by laminating a rubber sponge layer with an elastic composite fabric containing a certain amount of an elastic fiber. Although the aforesaid fabric is relatively high in stretch ability as compared to another conventional fabric for wet suits or heat-retaining suits containing no elastic fiber, it also has a high modulus of elasticity, which means that the wet suits or heat-retaining suits made of the fabric containing the elastic fiber impose an uncomfortable constraint to wearers.

### SUMMARY OF THE INVENTION

Therefore, the object of the present invention is to provide a method for producing a fabric having low modulus of elasticity and high stretch ability so as to alleviate the aforesaid disadvantages of the conventional wet suits or heat-retaining suits.

The method for producing a fabric having low modulus of elasticity and high stretch ability includes the steps of: (a) making an elastic composite fabric from an elastic fiber and a non-elastic fiber; (b) laminating the elastic composite fabric with a rubber sponge layer to form a laminate; (c) treating the elastic composite fabric of the laminate with a solvent so as to dissolve or break the elastic fiber; and (d) removing the solvent from the laminate.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a fabric produced by the first preferred embodiment of the method according to this invention; and

FIG. 2 is a schematic view of a fabric produced by the second preferred embodiment of the method according to this invention.

### DETAILED DESCRIPTION OF THE PREFERRED EMBODIMENTS

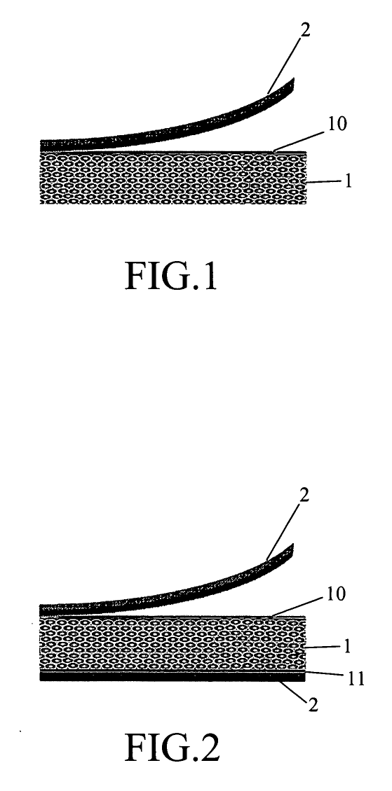

Referring to FIG. 1, a fabric having low modulus of elasticity and high stretch ability is shown, which is produced by the first preferred embodiment of the method according to this invention. The method includes the steps of:

A) Making an Elastic Composite Fabric 2:

The elastic composite fabric 2 is made from an elastic fiber and a non-elastic fiber. The elastic and non-elastic fibers can be formed into yarns, respectively, or can be mixed spun together to make a mixed spun yarn. The elastic fiber is made of polyurethane, and can be in a form of a bare yarn, a covering yarn, a core-spun yarn, a double-twisting yarn, and/or the like. The elastic fiber has a fineness ranging from 20 to 140 deniers. The non-elastic fiber is an artificial fiber or a natural fiber. The natural fiber useful in this invention is cotton, linen, silk, wool, and/or the like, and has a fineness ranging from 16 to 50 counts. The artificial fiber is synthetic fiber, semi-synthetic fiber, or regenerated fiber, and has a fineness ranging from 30 to 300 deniers. The synthetic fiber useful in this invention is polyamide fiber, polyester fiber, polyarylic fiber, and/or the like. The semi-synthetic fiber useful in this invention is acetate fiber, triacetate fiber, and/or the like. The regenerated fiber useful in this invention is rayon fiber, soy fiber, and/or the like.

The elastic composite fabric 2 can be made by a knitting or weaving process. The knitting process useful in this invention is flat knitting, round braiding, warp knitting, and/or the like. The weaving process useful in this invention is shuttle weaving or shuttleless weaving. When the elastic composite fabric 2 is made in a form of a knitting, it preferably has 45 to 65 inches in breadth, a 70 to 600 grams/yard ratio, 3-40 G in gauge, 30-70 wales/inch and 40-150 courses/inch in density, and 5-30 kgf/cm² in strength, and it preferably contains 1-30 wt % of the elastic fiber. When the elastic composite fabric 2 is made in a form of a woven fabric, it preferably has 45 to 65 inches in breadth, a 70 to 600 grams/yard ratio, 40-70 warps/inch and 40-70 wefts/inch in density, and 5-50 kgf/cm² in strength, and it preferably contains 1-30 wt % of the elastic fiber.

B) Laminating:

The elastic composite fabric 2 is laminated onto a surface 10 of a rubber sponge layer 1 to form a laminate. The useful material for making the rubber sponge layer 1 is 2-chloro-1,3 butadiene polymers and/or copolymers, styrene-butadiene rubber, nitrile butadiene rubber, ethylene-propylene rubber, and/or the like. The elastic composite fabric 2 and the rubber sponge layer 1 are laminated under an atmospheric pressure by using 2-chloro-1,3 butadiene polymers and/or copolymers as a binder. Preferably, the laminating temperature is set to range from 20 to 120° C., and the laminating rate is set to range from 5 to 20 meters/min. The laminate made thereby has 70 grams/yard or more, has a size of 125 cm×200 cm or 125 cm×300 cm, and contains 1-30 wt % of the elastic fiber.

C) Solvent-Treating:

The elastic composite fabric 2 of the laminate is treated with a solvent, which can dissolve or break the elastic fiber, and which does not harm the non-elastic fiber, so as to dissolve or break the elastic fiber contained in the elastic composite fabric 2. The solvent useful in the invention is dimethyl formamide, dimethyl acetamide, sodium hydroxide, tetrahydrofuran, biphenyl, chlorobenzene, phenolic, aromatic acid esters, and/or the like. The laminate can be dipped in the solvent, or be applied with the solvent locally, patternedly, or throughout. The linkages of the elastic fiber are destroyed by the solvent so as to dissolve or break the elastic fiber contained in the elastic composite fabric 2.

D) Removing the Solvent:

The solvent containing the dissolved or broken elastic fiber is removed by washing the laminate with water. The laminate is then dried in an oven at a temperature of 130-190° C. so as to obtain the fabric.

Referring to FIG. 2, a fabric made by the second preferred embodiment of the method according to this invention is illustrated. The second preferred embodiment is similar to the first preferred embodiment, except that two opposite surfaces 10, 11 of the rubber sponge layer 1 are laminated with the elastic composite fabrics 2, respectively.

Test results to compare the fabric made by the method according to this invention with the fabric made by the conventional method in terms of elastic modulus and elongation are shown in Table 1:

TABLE 1

| | | 120% | Elogation | |
|---|---|---|---|---|
| | 60% Elastic | Elastic | at 4.5 Kg | |
| | Modulus | Modulus | Load | |
| | (kg/60%) | (kg/120%) | (%) | Direction |
| Comparative | 1.26 | 2.72 | 181.87 | Warp |
| | 1.37 | 2.84 | 170.07 | Weft |
| Inventive | 0.79 | 1.66 | 212.04 | Warp |
| | 0.86 | 1.76 | 193.73 | Weft |

As shown in the above Table 1, the fabric made by the method according to this invention is significantly better in performance than the fabric made by the conventional method in the aspects of elastic elongation and low modulus.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A method for producing a fabric having low modulus of elasticity and high stretch ability, comprising the steps of:
(a) making an elastic composite fabric from an elastic fiber and a non-elastic fiber;
(b) laminating said elastic composite fabric with a rubber sponge layer to form a laminate;
(c) treating said elastic composite fabric of said laminate with a solvent so as to dissolve or break said elastic fiber; and
(d) removing said solvent from said laminate.

2. The method as claimed in claim 1, wherein said elastic fiber is made of polyurethane and is in a form selected from a group consisting of a bare yarn, a covering yarn, a core-spun yarn, and a double-twisting yarn, said elastic fiber having a fineness ranging from 20 to 140 deniers.

3. The method as claimed in claim 1, wherein said non-elastic fiber is selected from a group consisting of an artificial fiber and a natural fiber.

4. The method as claimed in claim 3, wherein said natural fiber is selected from a group consisting of cotton, linen, silk, and wool, and has a fineness ranging from 16 to 50 counts.

5. The method as claimed in claim 3, wherein said artificial fiber is selected from a group consisting of synthetic fiber, semi-synthetic fiber, and regenerated fiber, and has a fineness ranging from 30 to 300 deniers.

6. The method as claimed in claim 5, wherein said synthetic fiber is selected from a group consisting of polyamide fiber, polyester fiber, and polyarylic fiber.

7. The method as claimed in claim 5, wherein said semi-synthetic fiber is selected from a group consisting acetate fiber and triacetate fiber.

8. The method as claimed in claim 5, wherein said regenerated fiber is selected from a group consisting of rayon fiber and soy fiber.

9. The method as claimed in claim 1, wherein said elastic composite fabric is made by a knitting or weaving process.

10. The method as claimed in claim 9, wherein said knitting process is selected from a group consisting of flat knitting, round braiding, and warp knitting.

11. The method as claimed in claim 9, wherein said weaving process is selected from a group consisting of shuttle weaving and shuttleless weaving.

12. The method as claimed in claim 9, wherein said elastic composite fabric is a knitting which has 45 to 65 inches in breadth, a 70 to 600 grams/yard ratio, 3-40 G in gauge, 30-70 wales/inch and 40-150 courses/inch in density, and 5-30 kgf/cm² in strength, and which contains 1-30 wt % of said elastic fiber.

13. The method as claimed in claim 9, wherein said elastic composite fabric is a woven fabric which has 45 to 65 inches in breadth, a 70 to 600 grams/yard ratio, 40-70 warps/inch and 40-70 wefts/inch in density, and 5-50 kgf/cm² in strength, and which contains 1-30 wt % of said elastic fiber.

14. The method as claimed in claim 1, wherein said rubber sponge layer is made of a material selected from a group consisting of 2-chloro-1,3 butadiene polymers and copolymers, styrene-butadiene rubber, nitrile butadiene rubber, and ethylene-propylene rubber.

15. The method as claimed in claim 1, wherein said elastic composite fabric and said rubber sponge layer are laminated under an atmospheric pressure at a temperature of 20-120° C. by using 2-chloro-1,3 butadiene polymers and copolymers as a binder.

16. The method as claimed in claim 1, wherein said laminate has 70 grams/yard or more, and contains 1-30 wt % of said elastic fiber.

17. The method as claimed in claim 1, wherein said solvent is selected from a group consisting of dimethyl formamide, dimethyl acetamide, sodium hydroxide, tetrahydrofuran, biphenyl, chlorobenzene, phenolic, and aromatic acid esters.

18. The method as claimed in claim 1, wherein said solvent is removed by washing said laminate with water.

19. The method as claimed in claim 18, wherein said laminate is dried at a temperature of 130-190° C. after said laminate is washed.
